(19) United States
(12) Patent Application Publication
(10) Pub. No.: US 2010/0302342 A1
(43) Pub. Date: Dec. 2, 2010

(54) Audio and video messaging device

(76) Inventor: Jack Tang, Taipei Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/458,069

(22) Filed: Jun. 30, 2009

(30) Foreign Application Priority Data
May 27, 2009 (TW) 98209476

(51) Int. Cl. H04N 7/14

(52) U.S. Cl. 348/14.01; 348/E07.085

(57) ABSTRACT

An audio and video messaging device is composed of a shell, a control unit, a memory unit, a plurality of push buttons, a camera, a screen, a microphone, and a speaker. The control unit is mounted inside the shell. The memory unit is mounted inside the shell and electrically connected with the control unit. The push buttons are mounted onto the shell and electrically connected with the control unit. The camera is mounted onto the shell and electrically connected with the control unit. The screen is mounted onto the shell and electrically connected with the control unit. The microphone is mounted inside the shell and electrically connected with the control unit. The speaker is mounted inside the shell and electrically connected with the control unit.

### BACKGROUND OF THE INVENTION

1. Field of the Invention

The present invention relates generally to audio and video communication, and more particularly, to an audio and video messaging device.

2. Description of the Related Art

Since the modern society has become more and more industrialization and commercialization, people in many families are busy in life, such that it sometimes happens that one of the family members fails to reach another while intending to informing the same of something. For example, when there are some disputes between or among the spouses or brothers or sisters, if one of them feels like apologizing or suggesting something, it will be necessary to leave messages for communication. The conventional way to leave the messages is done on a notepaper, a blackboard, or a whiteboard. However, people are busy in the modern life, such that they tend to carelessly ignore the messages left on the aforesaid medium. Besides, the conventional messaging way is too boring without any visual and acoustic effects to fully express the feeling of the person leaving the messages or to emphasize something. Fortunately, as the technology keeps progressing, the dynamic audio and video messaging approach is likely available to enable a user to express his or her true feeling for better interactive attentive effect.

### SUMMARY OF THE INVENTION

The primary objective of the present invention is to provide an audio and video messaging device, which can record video and audio messages beforehand and then play the same for reminding, responsive, and attentive purposes.

The foregoing objective of the present invention is attained by the audio and video messaging device composed of a shell, a control unit, a memory unit, a plurality of push buttons, a camera, a screen, a microphone, and a speaker. The control unit is mounted inside the shell. The memory unit is mounted inside the shell and electrically connected with the control unit. The push buttons are mounted onto the shell and electrically connected with the control unit. The camera is mounted onto the shell and electrically connected with the control unit. The screen is mounted onto the shell and electrically connected with the control unit. The microphone is mounted inside the shell and electrically connected with the control unit. The speaker is mounted inside the shell and electrically connected with the control unit.

### BRIEF DESCRIPTION OF THE DRAWINGS

FIG. 1 is a perspective view of a first preferred embodiment of the present invention.

FIG. 2 is a block diagram of the first preferred embodiment of the present invention.

FIG. 3 is an exploded view of the first preferred embodiment of the present invention.

FIG. 4 is a sectional view taken from a line 4-4 indicated in FIG. 1.

FIG. 5 is another perspective view of the first preferred embodiment of the present invention.

FIG. 6 is a schematic view of the first preferred embodiment of the present invention fixed to an external side of a refrigerator door.

FIG. 7 is a schematic view of the first preferred embodiment of the present invention fixed to a stand.

FIG. 8 is a schematic view of a second preferred embodiment of the present invention mounted to a stand.

FIG. 9 is a schematic view of a third preferred embodiment of the present invention clipping to a stand.

### DETAILED DESCRIPTION OF PREFERRED EMBODIMENTS

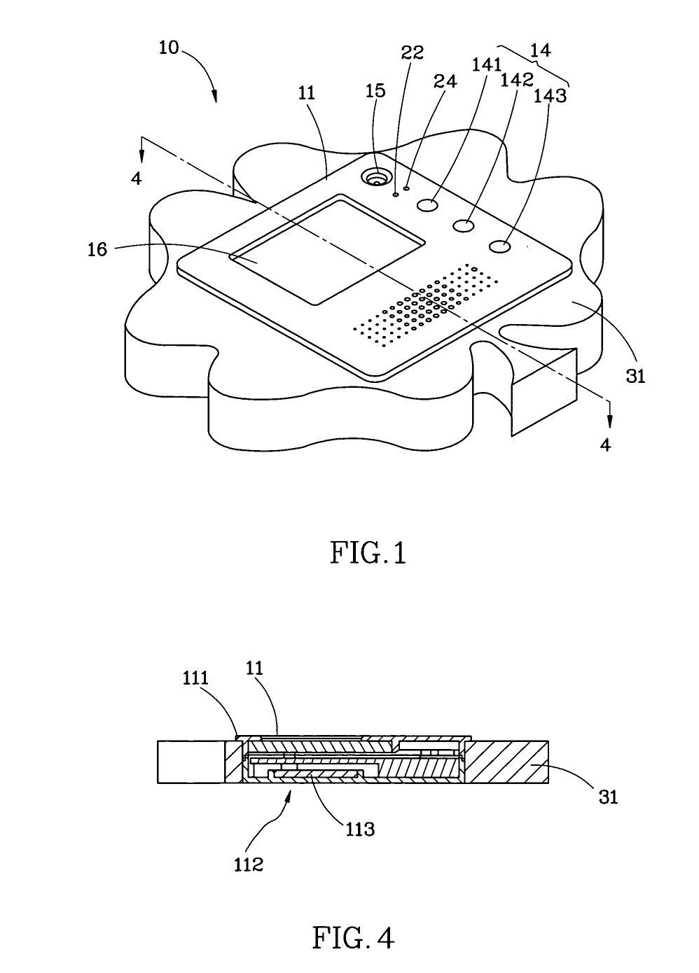

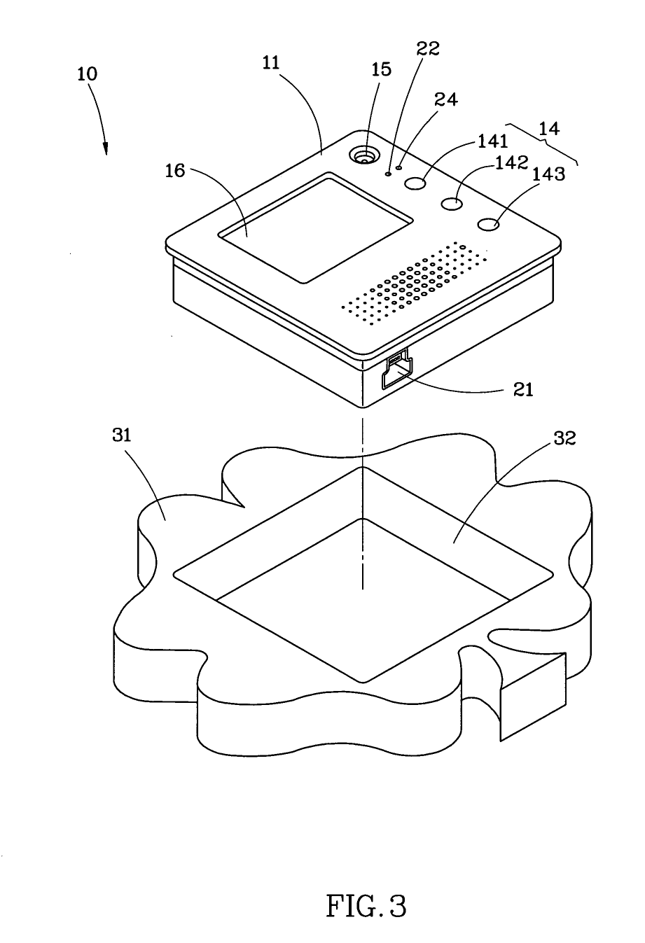

Referring to FIGS. 1-4, an audio and video messaging device 10 constructed according to a first preferred embodiment of the present invention is composed of a shell 11, a control unit 12, a memory unit 13, three push buttons 14, a camera 15, a screen 16, a microphone 17, a speaker 18, an input/output interface 21, a first indicator 22, a second indicator 24, and a decorative holder 31. All of the components of the audio and video messaging device 10 are recited in the following respective paragraphs.

The shell 11 includes a convex portion 111 and a fastening portion 112. The convex portion 111 extends parallel outward from a peripheral edge of a top side of the shell 11. The fastening portion 112 is formed at a bottom side of the shell 11 for fastening the shell 11 to an object.

The control unit 12 is mounted inside the shell 11. The memory unit 13 is mounted inside the shell 11 and electrically connected with the control unit 12. The push buttons 14 are mounted inside the shell 11 and electrically connected with the control unit 12, for generating and transmitting a signal to the control unit 12 after externally pushed. The push buttons 14 includes a power button 141, a record button 142, and a playback button 143. The camera 15 is mounted onto the shell 11 and electrically connected with the control unit 12, for capturing images within a predetermine range. The screen 16 is mounted onto the shell 11 and electrically connected with the control unit 12, for displaying the images. The microphone 17 mounted inside the shell 11 and electrically connected with the control unit 12, for recording sounds. The speaker 18 is mounted inside the shell 11 and electrically connected with the control unit 12, for playing the sounds.

The input/output interface 21 is mounted onto the shell 11 and electrically connected with the control unit 12, for enabling the audio and video messaging device 10 to be connected with a computer for data transmission.

The first indicator 22 is mounted to the shell 11 and electrically connected with the control unit 12. The second indicator 24 is mounted to the shell 11 and electrically connected with the control unit 12.

The decorative holder 31 includes a receiving space 32 matching the shell 11 in shape for receiving the shell 11. The convex portion 111 is stopped against the top side of the shell 11 close to an opening of the receiving space 32.

When the user intends to operate the audio and video messaging device 10 for recordation, the user can push the power button 141 and then wait for illumination of the first indicator 22, meanwhile the audio and video messaging device 10 being activated; then push the record button 142 and demonstrate video and sound that the user intends to demonstrate in front of the camera 15 and the microphone 17; meanwhile, the video data captured by the camera 15 and the audio data captured by the microphone 17 are recorded into the memory unit 13. Next, the user can push the record button 142 again to complete the video and audio recordation, and then the second indicator 24 lights up to indicate that an audio and video message is recorded in the audio and video messaging device 10. When the user intends to have access to the recorded video and audio message, the user can push the playback button 143 and then the video and audio data can be played via the screen 16 and the speaker 18 respectively from the memory unit 13.

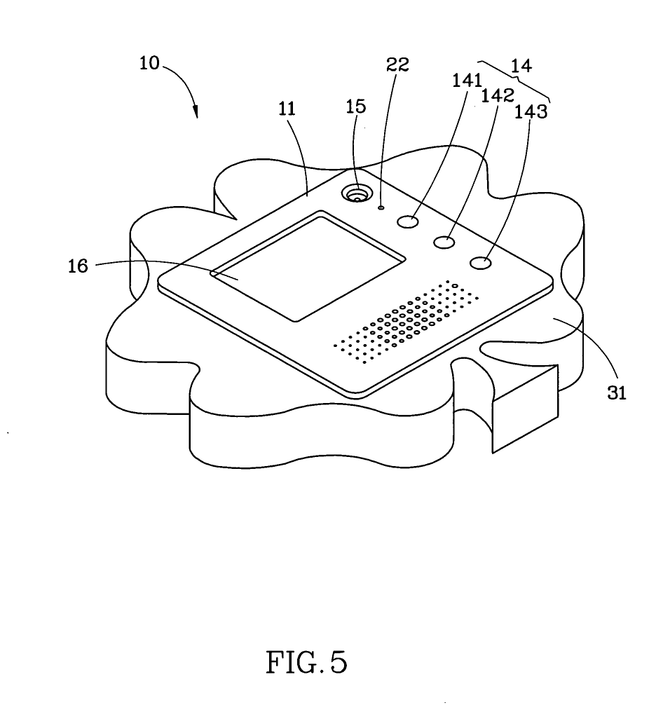

Referring to FIG. 5, the second indicator 24 can be spared from the audio and video messaging device 10. When the audio and video messaging device 10 is activated, the first indicator 22 lights up in green. When the video and audio recordation is completed, the first indicator lights up in red, indicating the video and audio message is recorded. Alternatively, the first indicator 22 can keep illumination to indicate that the audio and video messaging device 10 is activated and keep flashing to indicate that the video and audio message is recorded. Under the circumstances, the first indicator 22 can also do the function of the second indicator 24.

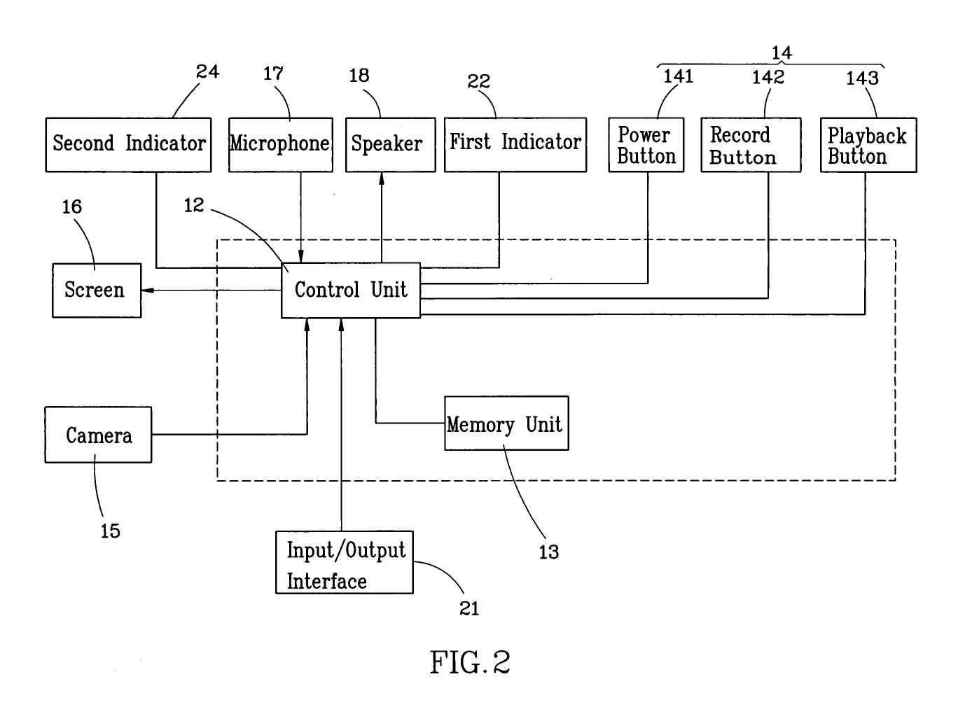

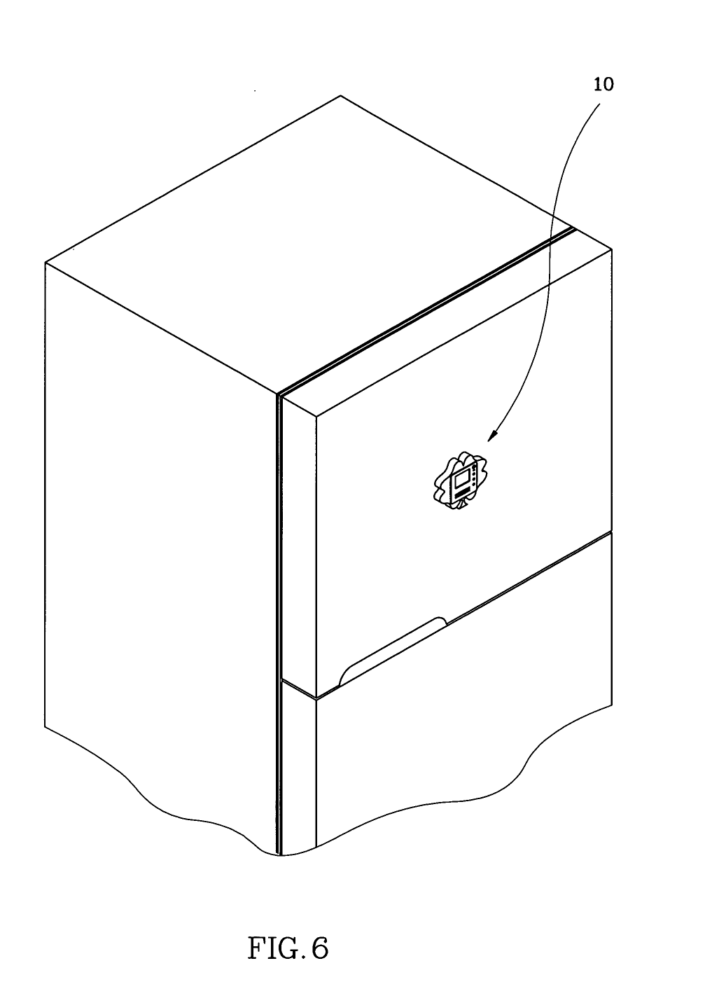

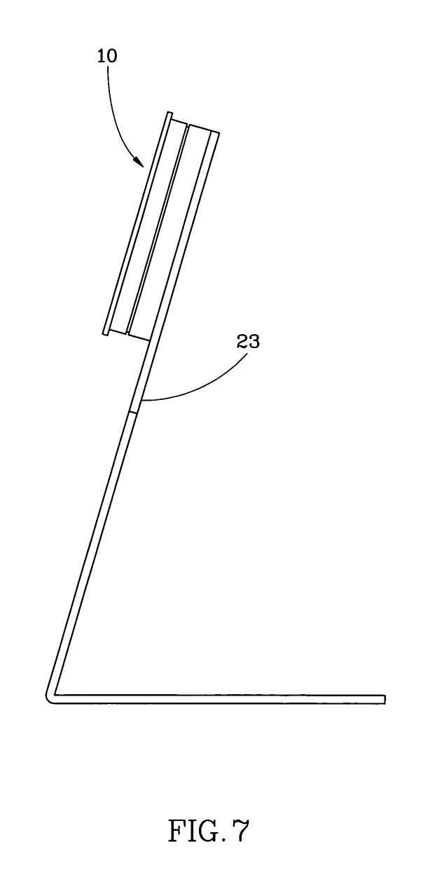

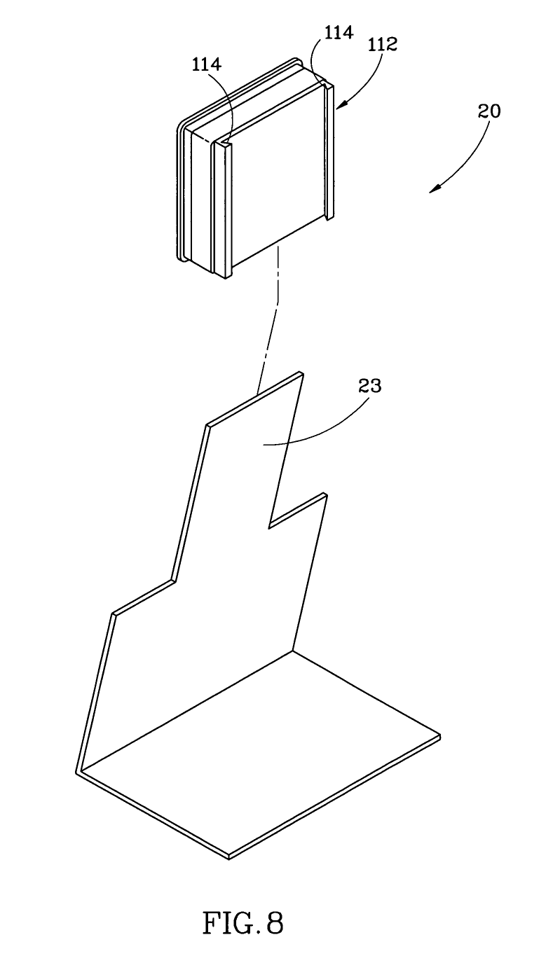

Referring to FIGS. 6-7 in view of FIGS. 2 & 4, the fastening portion 112 includes a magnet 113, such that the audio and video messaging device 10 can be magnetically attached to a magnetically susceptible member, such as a door of a refrigerator (FIG. 6) and a stand (FIG. 7). For aesthetic appearance, the decorative holder 31 has a designed shape, which is like a tree in this embodiment as shown in FIG. 6.

Referring to FIG. 8, an audio and video messaging device 20 constructed according to a second preferred embodiment of the present invention is similar to that of the first embodiment, having the following difference from the same. The fastening portion of the second embodiment is a dovetailed groove 114 in such a way that the audio and video messaging device 20 can be mounted to the stand 23 by dovetail joint.

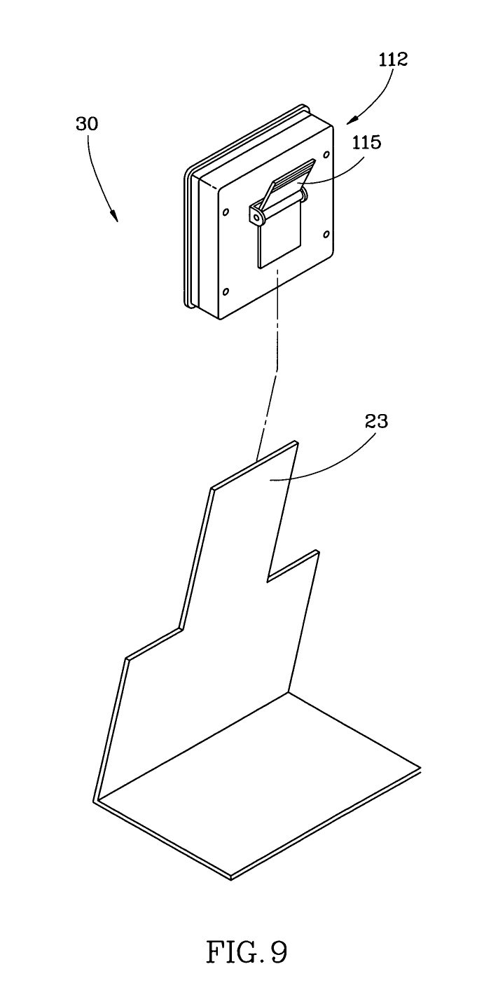

Referring to FIG. 9, an audio and video messaging device 30 constructed according to a third preferred embodiment of the present invention is similar to that of the first embodiment, having the following difference from the same. The fastening portion of the third embodiment is a clip 115 in such a way that the audio and video messaging device 30 can clip to the stand 23.

In conclusion, the audio and video messaging device of the present invention can allow the user to record audio and video messages beforehand and to play the same in due course for reminding, responsive, and attentive purposes.

Although the present invention has been described with respect to specific preferred embodiments thereof, it is no way limited to the details of the illustrated structures but changes and modifications may be made within the scope of the appended claims.

What is claimed is:

1. An audio and video messaging device comprising:
a shell;
a control unit mounted inside the shell;
a memory unit mounted inside the shell and electrically connected with the control unit;
a plurality of push buttons mounted to the shell and electrically connected with the control unit;
a camera mounted to the shell and electrically connected with the control unit;
a screen mounted to the shell and electrically connected with the control unit;
a microphone mounted inside the shell and electrically connected with the control unit; and
a speaker mounted inside the shell and electrically connected with the control unit.

2. The audio and video messaging device as defined in claim 1 further comprising an input/output interface, wherein the input/output interface is mounted to the shell and electrically connected with the control unit for connection with a computer for data transmission.

3. The audio and video messaging device as defined in claim 1 further comprising a fastening portion for fastening the audio and video messaging device to an object.

4. The audio and video messaging device as defined in claim 3, wherein the fastening portion is a magnet or a dovetailed groove or a clip.

5. The audio and video messaging device as defined in claim 1, wherein the shell comprises a convex portion extending outward from a peripheral edge of a top side thereof; the audio and video messaging device further comprises a decorative holder having a receiving space matching the shell in shape, the shell being mounted into the receiving space; the fastening portion is stopped against the top side of the shell close to an opening of the receiving space.

6. The audio and video messaging device as defined in claim 1 further comprising a first indicator, wherein the first indicator is mounted to the shell and electrically connected with control unit.

7. The audio and video messaging device as defined in claim 6 further comprising a second indicator, wherein the second indicator is mounted to the shell and electrically connected with the control unit.

8. The audio and video messaging device as defined in claim 6, wherein the first indicator can adjust its display manner to indicate that the audio and video messaging device is activated or an audio and video message is recorded.

9. The audio and video messaging device as defined in claim 8, wherein the display manner of the first indicator is change of colors or variation of illumination.
